(19) United States
(12) Patent Application Publication
(10) Pub. No.: US 2010/0109872 A1
(43) Pub. Date: May 6, 2010

(54) Radio Frequency Identification Integrated Circuit Having An Antenna Incorporated Within The Package Thereof

(76) Inventors: Ziv Geva, Rehovot (IL); Ofer Leizerovich, Nes-Ziona (IL)

Correspondence Address: The Law Office of Michael E. Kondoudis, 888 16th Street, N.W., Suite 800, Washington, DC, 20006, US

(21) Appl. No.: 12/264,874

(22) Filed: Nov. 4, 2008

(51) Int. Cl. G08B 13/14

(52) U.S. Cl. 340/572.7

(57) ABSTRACT

A radio frequency identification (RFID) integrated circuit (IC) with an antenna embedded within the package of the IC. Thus, the RFID IC is a standalone identifying device that may be easily attached to a PCB in any currently available attaching process. There is also provided a method of tagging a PCB. The method comprises attaching a master RFID IC with an antenna embedded within the IC package on a predefined location on a printed circuit card; delivering the information stored on plurality of slave RFID ICs on the same printed circuit board to the master RFID IC; and reading from the predefined location of the master RFID IC data pertaining to each slave RFID IC.

### BACKGROUND

1. Technical Field

The present invention relates to radio frequency identification integrated circuits and in particular to radio frequency identification integrated circuits having an antenna incorporated within the package thereof.

2. Related Art

Radio frequency identification (RFID) technology is increasingly becoming the identification method of choice for a wide variety of products. An RFID integrated circuit (IC) usually comprises an RF module usually having an antenna and a modulating and demodulating unit. In addition, the RFID IC comprises data storage that interacts with a reader via a controller and the RF module on the IC.

Sometimes only the RFID module within the IC is used such that is it embedded within the product that needs to be identified.

RFID ICs are operatively associated with RFID readers the interact and communicate with the RFID ICs by means of sending RFID inquiry usually pertaining to specific data stored on the RFID ICs.

Printed circuit boards (PCBs) that are used for electronic appliances usually comprise a plurality of integrated circuits cooperating within the same system. Each integrated chip is affiliated with its own properties, usually attributed in the production process.

It is a challenging task to obtain comprehensive data from each and every integrated circuit on a single printed circuit board using traditional means.

There is therefore a need for a uniform manner for accumulating information pertaining to all electronic components on a particular PCB and then retrieving the information from a single identifier.

### BRIEF SUMMARY

Accordingly, it is a principal object of the present invention, in embodiments thereof, to provide a radio frequency identification (RFID) integrated circuit (IC) having an antenna embedded within the package of the IC. Thus, the RFID IC is a standalone identifying device that may be easily attached to a PCB in any currently available attaching process.

According to one aspect of the invention, there is provided a radio frequency identification (RFID) integrated circuit (IC) comprising: a storage module; a radio frequency module; an antenna; and a package, wherein the storage module, the radio frequency module, and the antenna are physically embedded within the package.

According to another aspect of the invention there is provided an array of radio frequency identification (RFID) integrated circuits (ICs) exhibiting an antenna embedded within the package thereof, operatively associated with a RFID reader capable of making RFID inquiries, the array comprising: a master RFID IC attached to a printed circuit board in a predefined location and operable to store data thereon; and a plurality of slave RFID IC, each attached to the printed circuit board and operable to store data thereon, wherein said master RFID module is arranged to: store data from all slave RFID ICs; and transmit data pertaining to RFID slave ICs to the reader.

According to yet another aspect of the invention, there is provided a method of attaching a radio frequency identification (RFID) integrated circuit (IC) on a predefined surface, the method comprising: attaching a master RFID IC with an antenna embedded within an IC package on a predefined location on a printed circuit card; delivering information stored on a plurality of slave RFID ICs on the same printed circuit board to the master RFID IC; and reading from the predefined location of the master RFID IC data pertaining to each slave RFID IC.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a high level block diagram showing an RFID module with RFID antenna coupled to an RFID module both embedded within a package according to some embodiments of the present invention;

FIG. 2 is a high level block diagram showing RFID ICs array according to some embodiments of the present invention; and

FIG. 3 is a high level flow chart showing a method according to some embodiments of the present invention.

The drawings together with the description make apparent to those skilled in the art how the invention may be embodied in practice.

### DETAILED DESCRIPTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

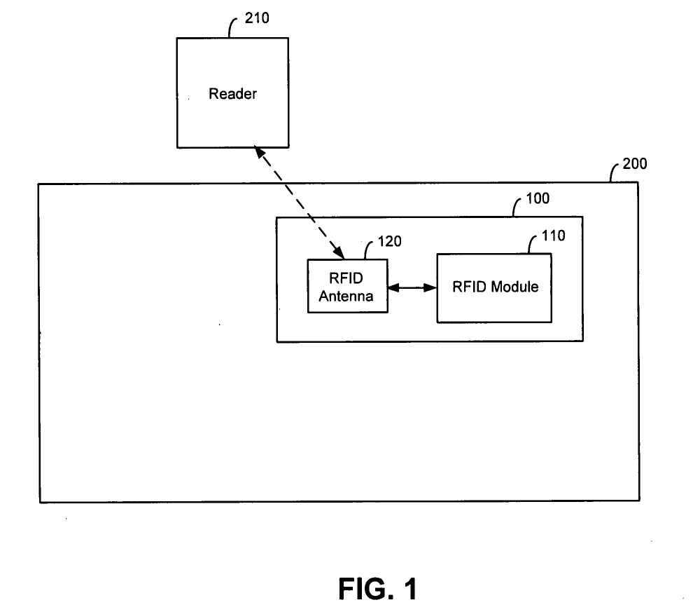

FIG. 1 shows a high level schematic block diagram of a radio frequency identification (RFID) IC 100 attached to a PCB 200 and operatively associated with an RFID reader 210 capable of making RFID inquiries. RFID IC 100 comprises an RFID module 110 coupled to an RFID antenna 120, wherein the RFID module 110 and the RFID antenna 120 are embedded together within the package of IC 100.

According to some embodiments, RFID IC 100 may be arranged to be attached to any surface, specifically but not limited to a PCB, in any attaching technology such as SMT, gluing, reflow and the like. RFID IC 100 may also be embedded within a plastic (or any other material) mold during production.

According to some embodiments, RFID IC 100 may be further arranged to be located on a specific mount (preferably made of, but not limited to, aluminum). The mount may have an identification number attached thereon so that some identification means remain if the RFID IC 100 is removed.

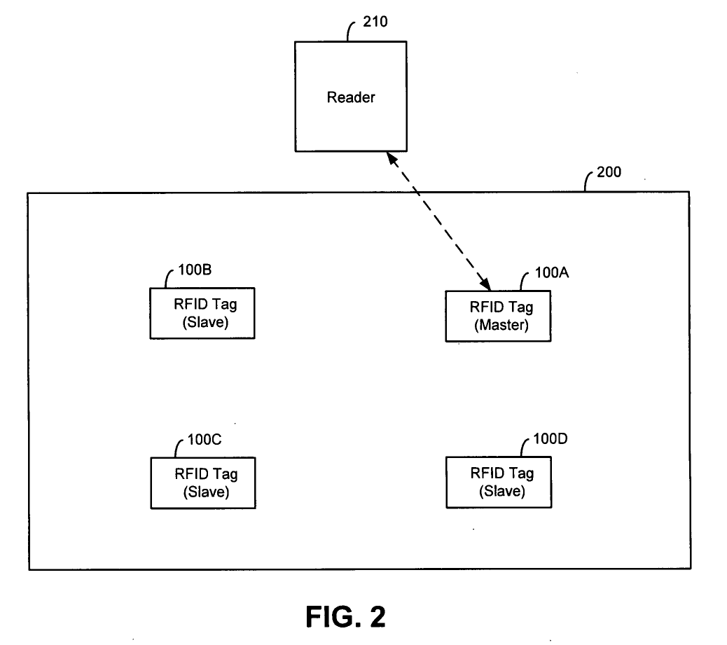

FIG. 2 shows a high level schematic block diagram of an array of RFID ICs 100A-D, each IC attached as an electronic component on a PCB 200 and operable to store data thereon. Specifically, one of the RFID IC is located on a PCB 200 in a predefined location. This IC being the master RFID IC 100A and may be arranged to store data pertaining to the other ICs, being the slave RFID ICs.

In operation, subsequently after attaching the master RFID IC 100A, all information from slave RFID ICs 100B-D may copied by reader 210 and transferred and stored on master RFID IC 100A. From this point onward, retrieval of information regarding all RFID ICs is done from a single RFID—the master RFID IC.

According to some embodiments of the invention, the RFID ICs are loaded with data during production process of said integrated circuits.

According to some embodiments of the invention, the data loaded on the RFID ICs comprise data pertaining to ant of the following aspects: integrated circuit functionality, date of production, batch number, properties, model, type, power consumption, and the like.

According to some embodiments of the invention, the processing module within the RFID reader is further arranged to control the RFID circuitry to communicate with any selected slave RFID module directly.

The main processing module of the reader can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices. The processor and the memory can be supplemented by, or incorporated in, ASICs (application-specific integrated circuits).

To provide for interaction with a user, the reader can be implemented on a computer having a display device such as a LCD (liquid crystal display) monitor for displaying information to the user and a keyboard and a pointing device such as a mouse or a trackball by which the user can provide input to the computer.

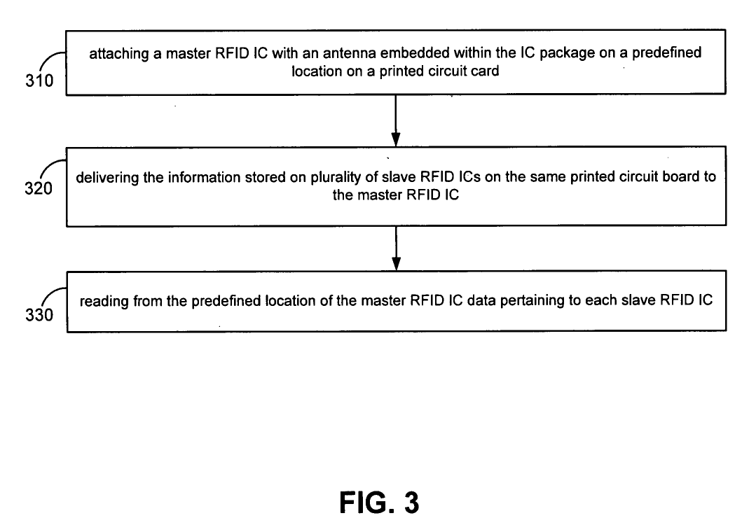

FIG. 3 is a high level flow chart showing the method for attaching RFID IC on a predefined surface, the method comprising: attaching a master RFID IC with an antenna embedded within the IC package on a predefined location on a printed circuit card 310; delivering the information stored on plurality of slave RFID ICs on the same printed circuit board to the master RFID IC 320; and reading from the prede fined location of the master RFID IC data pertaining to each slave RFID IC 330.

According to some embodiments of the invention, the method further comprises the step of generating an RFID inquiry directed at and pertaining to at least one slave RFID module. Thus the reader may directly access any RFID module.

According to some embodiments of the invention the stage of relaying corresponding data from slave RFID module is performed by the master RFID module.

According to some embodiments of the invention at least one RFID module of the RFID array is embedded within an integrated circuit having a package.

According to some embodiments of the invention the disclosed method is preceded by the stage of loading data on the RFID ICs being data pertaining to at least one of the following: integrated circuit functionality, date of production, batch number, properties, model, type, power consumption.

According to some embodiments of the invention, relaying corresponding data from a slave RFID is directed at an RFID reader.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A radio frequency identification (RFID) integrated circuit (IC) comprising:
a storage module;
a radio frequency module;
an antenna; and
a package,
wherein the storage module, the radio frequency module, and the antenna are physically embedded within the package.

2. The RFID integrated circuit according to claim 1, wherein the package is arranged for attaching on predetermined surfaces.

3. The RFID integrated circuit according to claim 2, wherein the surface is a printed circuit board.

4. The RFID integrated circuit according to claim 1, wherein the RFID IC is loaded with data during a production process thereof.

5. The RFID integrated circuit according to claim 1, wherein the data loaded on said RFID IC is data pertaining to at least one of: integrated circuit functionality; a date of production; a batch number; a model indicia; a type; and power consumption.

6. An array of radio frequency identification (RFID) integrated circuits (ICs) exhibiting an antenna embedded within the package thereof, operatively associated with a RFID reader capable of making RFID inquiries, the array comprising:
a master RFID IC attached to a printed circuit board in a predefined location and operable to store data thereon; and
a plurality of slave RFID IC, each attached to the printed circuit board and operable to store data thereon,
wherein said master RFID module is arranged to:
store data from all slave RFID ICs; and
transmit data pertaining to RFID slave ICs to the reader.

7. The RFID array according to claim 6, wherein the RFID ICs are loaded with data during a production process of the integrated circuits.

8. The RFID array according to claim 6, wherein the data loaded on the RFID ICs is data pertaining to at least one of the following: integrated circuit functionality; a date of production; a batch number; a model indicia; a type; and power consumption.

9. A radio frequency identification (RFID) reader operatively associated with an RFID array comprising a master RFID module in communication with a plurality of slave RFID ICs, the reader comprising:
an RFID circuitry;
a main processing module coupled to the RFID circuitry;
wherein the main processing module is arranged to control RFID circuitry to communicate over an RFID channel solely with the master RFID module that in turn communicates with the slave RFID ICs.

10. The RFID reader of claim 7, wherein the main processing module is further arranged to control the RFID circuitry to communicate with any selected slave RFID module directly.

11. A method of attaching a radio frequency identification (RFID) integrated circuit (IC) on a predefined surface, the method comprising:
attaching a master RFID IC with an antenna embedded within an IC package on a predefined location on a printed circuit card;
delivering information stored on plurality of slave RFID ICs on the same printed circuit board to the master RFID IC; and
reading from the predefined location of the master RFID IC data pertaining to each slave RFID IC.

12. The method of claim 11, wherein at least one RFID module of the RFID array is embedded within an integrated circuit having a package.

13. The method of claim 12, wherein the RFID ICs are loaded with data during a production process of the integrated circuits.

14. The method of claim 12, wherein the data loaded on the RFID ICs are data pertaining to at least one of the following: integrated circuit functionality; a date of production; a batch number; a model indicia; a type; and power consumption.
